(19) United States
(12) Patent Application Publication
(10) Pub. No.: US 2009/0327463 A1
(43) Pub. Date: Dec. 31, 2009

(54) Information Processing Apparatus and Boot Method Thereof

(75) Inventor: Toshimitsu Saito, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/356,449

(22) Filed: Jan. 20, 2009

(30) Foreign Application Priority Data
Jun. 30, 2008 (JP) 2008-170836

(51) Int. Cl. G06F 15/177

(52) U.S. Cl. 709/222; 713/2

(57) ABSTRACT

According to one embodiment, an information processing apparatus that is connectable to a server that stores an operating system (OS) includes a data storage module, a setting storage module, a controller, and a boot module. The data storage module stores data. The setting storage module stores setting information indicating either a first mode using the data storage module or a second mode not using the data storage module. The controller retrieves the setting information from the setting storage module before an OS boots up, and, when the setting information indicates the second mode, disables access to the data storage module. The boot module loads, when access to the data storage module is disabled, the OS from the server, and boots up the OS.

### CROSS-REFERENCE TO RELATED APPLICATIONS

This application is based upon and claims the benefit of priority from Japanese Patent Application No. 2008-170836, filed Jun. 30, 2008, the entire contents of which are incorporated herein by reference.

### BACKGROUND

1. Field

One embodiment of the invention relates to an information processing apparatus that comprises a storage medium and serves as a thin client not using the storage medium, and a boot method thereof.

2. Description of the Related Art

In view of reducing the risk of information compromise to enhance security as well as lowering total cost of ownership (TCO) for managing applications and data, thin client PCs have attracted attention, and are increasingly used in offices. Besides, PCs for use as a thin client are commercially available that do not have a storage medium such as HDD and CD-ROM.

One approach to implement a thin client system can be to purchase a PC for use as a thin client, which results in higher cost. Another approach can be to use a normal PC provided with a storage medium as a thin client PC.

Japanese Patent Application Publication (KOKAI) No. 2007-310822 discloses an information processing system that achieves the same effect as a thin client system at low cost. The information processing system includes an information control server that manages output environment limiting data. In the information processing system, availability of access to the internal memory is determined based on the output environment limiting data received from the information control server.

To use a normal PC as a thin client PC, there is a need to construct a mechanism for preventing information from remaining in a storage medium built in the PC by changing or modifying the OS or drivers.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a personal computer as an information processing apparatus according to an embodiment of the invention;

FIG. 2 is an exemplary block diagram of the personal computer in the embodiment;

FIG. 3 is an exemplary flowchart of a boot process in the embodiment;

FIG. 4 is an exemplary flowchart of a BIOS set-up process in the embodiment;

FIG. 5 is an exemplary diagram of a set-up menu screen in the embodiment; and

FIG. 6 is an exemplary flowchart of a BIOS set-up process according to a modification of the embodiment.

### DETAILED DESCRIPTION

Various embodiments according to the invention will be described hereinafter with reference to the accompanying drawings. In general, according to one embodiment of the invention, an information processing apparatus that is connectable to a server that stores a first operating system (OS), comprises: a data storage module configured to store a second OS; a setting storage module configured to store setting information indicating either a first mode enabling access to the data storage module or a second mode disabling access to the data storage module; a controller configured to retrieve the setting information from the setting storage module before the first OS or the second OS boots up, and, when the setting information indicates the second mode, disable access to the data storage module, and when the setting information indicates the first mode, enable access to the data storage module; and a boot module configured to load, when the setting information indicates the first mode, the first OS from the server or the second OS from the data storage module in descending order of predetermined priority and boot up the first OS or the second OS after loading the first OS or the second OS, and configured to load, when the setting information indicates the second mode, the first OS from the server regardless of the priority and boot up the first OS.

According to another embodiment of the invention, a boot method applied to an information processing apparatus that is connectable to a server storing an operating system (OS) and includes a data storage module and a setting storage module, comprises: retrieving, before an OS boots up, setting information that indicates either a first mode using the data storage module that stores data or a second mode not using the data storage module from the setting storage module; disabling, when the setting information indicates the second mode, access to the data storage module; and loading, when access to the data storage module is disabled, the OS from the server, and booting up the OS.

Described below is an information processing apparatus according to an embodiment of the present invention. The information processing apparatus of the embodiment has a function of switching between normal PC mode for using a storage medium and thin client PC mode for disabling access to a storage medium as hardware. When in the thin client PC mode, the information processing apparatus functions as a thin client PC since a storage medium is disabled so that it cannot be physically used.

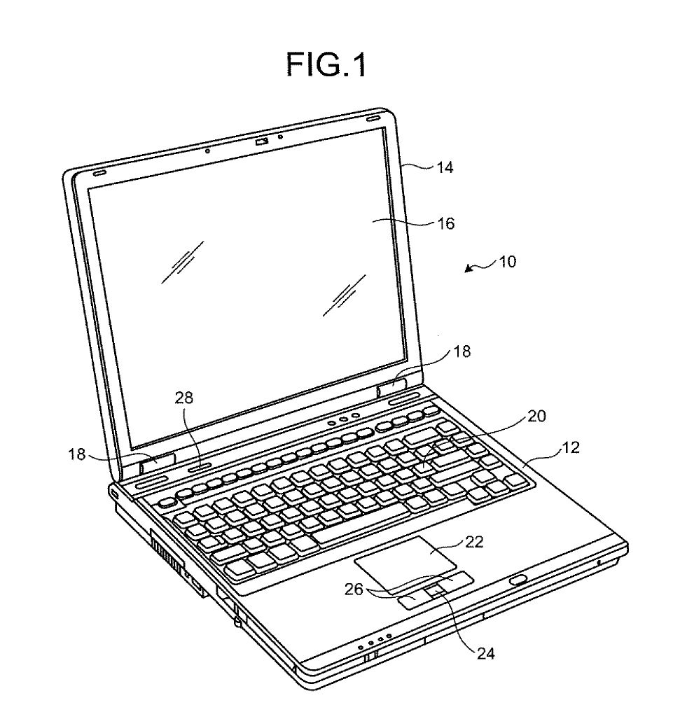

FIG. 1 is a perspective view of a notebook personal computer (PC) 10 as an information processing apparatus according to the embodiment.

The PC 10 comprises a main body 12 and a display unit

14. The display unit 14 comprises a liquid crystal display (LCD) 16 as a display panel.

The display unit 14 is attached to hinges (supporting members) 18 provided on the rear edge of the main body 12. This allows the display unit 13 to rotate freely between an open position and a closed position. The display unit 14 covers over the upper surface of the main body 12 in the closed position, while it exposes the upper surface of the main body 12 in the open position.

The main body 12 has a chassis in a flat box-shape. In the center of the upper surface of the chassis is provided a keyboard (KB) 20. On the front side of the main body 12, a palm rest is provided on the upper surface of the chassis. In substantially the center of the palm rest are arranged a touchpad 22, a scroll button 24, and a touchpad control button 26. On the rear side of the main body 12, a power button 28 is provided on the upper surface of the chassis for turning on/off the PC 10.

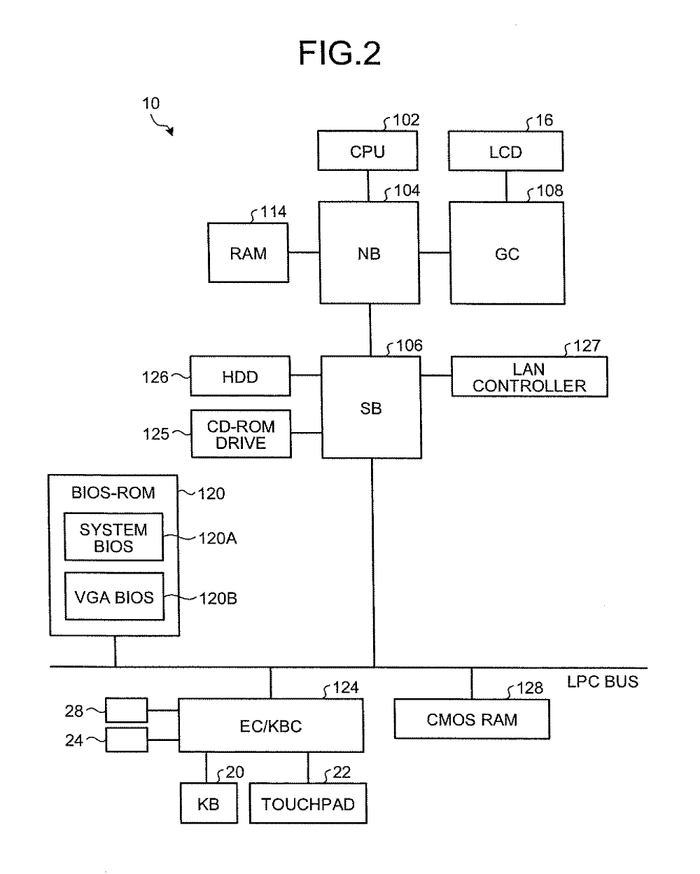

An example of the system configuration of the PC 10 will be described with reference to FIG. 2. FIG. 2 is a block diagram of the PC 10.

As illustrated in FIG. 10, the PC 10 comprises a CPU 102, a north bridge (NB) 104, a random access memory (RAM) 114, a graphics controller (GC) 108, a south bridge (SB) 106, a basic input/output system read only memory (BIOS-ROM) 120, a CD-ROM drive 125, a hard disk drive (HDD) 126, a LAN controller 127, an embedded controller/keyboard controller IC (EC/KBC) 124, a complementary metal-oxide semiconductor (CMOS) RAM 128. The RAM 114 is the main memory of the PC 10.

The CPU 102 controls the operation of the PC 10, and executes an operating system (OS) and various application programs loaded from the HDD 126 into the RAM 114.

The CPU 102 also loads a system BIOS 120A and a video graphics array (VGA) BIOS 120B from the BIOS-ROM 120 into the RAM 114 and executes them. The system BIOS 120A is a program to control hardware. The RAM 114 operates faster than the BIOS-ROM 120.

The VGA BIOS 120B is a program to control the graphics controller 108. The VGA BIOS 120B includes two programs, i.e., an initialization program for initializing the graphics controller 108 and a runtime program. To reduce the required capacity of the BIOS-ROM 120, the two programs are stored in the BIOS-ROM 120 in such a manner that they share a part of the components.

The north bridge 104 connects between the local bus of the CPU 102 and the south bridge 106. The north bridge 104 has a built-in memory controller for controlling access to the RAM 114. The north bridge 104 has a function of communicating with the graphics controller 108 through an accelerated graphics port (AGP) bus or the like.

The graphics controller 108 is a display controller that controls the LCD 16 used as the display monitor of the PC 10. The graphics controller 108 is provided with a video memory (VRAM), and, based on display data written by an OS/application program to the video memory, generates an image signal to display an image on the LCD 16. The graphics controller 108 outputs the image signal to a line.

The south bridge 106 controls each device on a low pin count (LPC) bus and a peripheral component interconnect (PCI) bus. For example, the south bridge 106 is connected via the PCI bus to the LAN controller 127 for transmitting data to a device through a network.

The south bridge 106 has a built-in integrated drive electronics (IDE) controller that controls the CD-ROM drive 125 and the HDD 126. Further, the south bridge 106 has a function of controlling access to the BIOS-ROM 120.

The IDE controller is set to “Enable”/“Disable” to enable/disable access to the CD-ROM drive 125 and the HDD 126, respectively.

The CD-ROM drive 125 and the HDD 126 each function as a data storage module that stores data. In addition to the CD-ROM drive 125 and the HDD 126, various other computer-readable storage media can be used to store data. Examples of such storage media include, but are not limited to, a flexible disk (FD), a compact disk recordable (CD-R), a digital versatile disk (DVD), a memory card including an SD card, a universal serial bus (USB) memory.

The embedded controller/keyboard controller IC 124 controls the touchpad 22, the scroll button 24, and the touchpad control button 26. The embedded controller/keyboard controller IC 124 is a one-chip microcomputer that monitors and controls various devices (peripheral devices, sensors, power circuit, etc.) independently of the system state of the PC 10.

The CMOS RAM 128 stores the settings of the system BIOS 120A and information on whether the PC 10 is in suspend mode as information necessary to boot up the PC 10.

As described above, the BIOS-ROM 120 stores the system BIOS 120A and the VGA BIOS 120B. The BIOS-ROM 120 also functions as a setting storage module that stores various types of setting information necessary to execute each BIOS. In the embodiment, examples of the setting information stored in the BIOS-ROM 120 include PC modes that determine the operation of the PC 10. The PC modes includes normal PC mode and thin client PC mode. The normal PC mode allows access to the data storage module, such as the CD-ROM drive 125 and the HDD 126, so that the PC 10 can be used as a normal computer. On the other hand, the thin client PC mode disables access to the data storage module so that the PC 10 can be used as a thin client PC.

The setting information need not necessarily be stored in the BIOS-ROM 120, and can be stored in, for example, the CMOS RAM 128.

The system BIOS 120A has a function of booting up the PC 10 with reference to the information stored in the CMOS RAM 128, the setting information stored in the BIOS-ROM 120, and the like. This function includes a function of loading an OS from a storage medium according to boot priority and executing it. The boot priority defines the priority of storage media from which an OS is loaded to execute. In other words, the boot priority specifies the order of boot options, such as boot from the HDD 126, boot from the CD-ROM drive 125, and network boot, to select one of them that is effective or currently available.

The network boot is a way of booting up the PC 10 by using an OS loaded from a predetermined server through the LAN controller 127. For example, if access to the CD-ROM drive 125 and the HDD 126 is disabled, the network boot is selected as being effective. In this case, the PC 10 boots up as a thin client PC that does not allow access to the CD-ROM drive 125 and the HDD 126.

Besides, the system BIOS 120A has a function of reading the PC mode from the BIOS-ROM 120 to control enabling/disabling of access to the CD-ROM drive 125 and the HDD 126 depending on the PC mode. More specifically, when the PC 10 is in the normal PC mode, access to the CD-ROM drive 125 and the HDD 126 is enabled. When the PC 10 is in the thin client PC mode, access to the CD-ROM drive 125 and the HDD 126 is disabled.

By loading the system BIOS 120A having the functions as above and executing it, the CPU 102 functions as a controller for controlling access to the CD-ROM drive 125 and the HDD 126 and also as a boot module for booting up the OS.

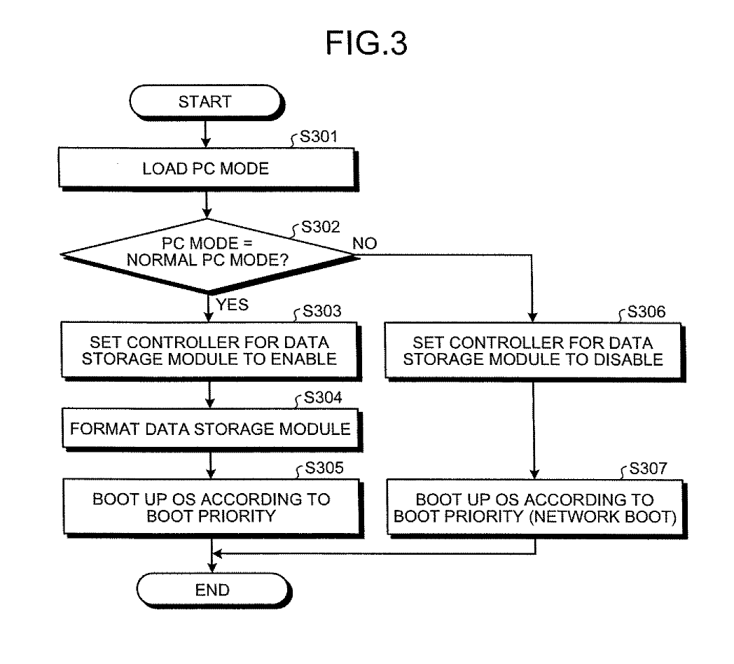

With reference to FIG. 3, a description will be given of a boot process on the PC 10 of the embodiment configured as described above. FIG. 3 is a flowchart of the boot process according to the embodiment.

The term “boot process” as used herein refers to the process of booting up the PC 10, which is performed by the CPU 102 that has loaded the system BIOS 120A when the PC 10 is turned on with the press of the power button 28. FIG. 3 mainly illustrates the process of formatting the data storage module such as the CD-ROM drive 125 and the HDD 126. Although not shown in FIG. 3, various other processes that the boot-up requires are also performed, including the process of formatting each device such as the graphics controller 108.

First, the CPU 102 loads the PC mode from the BIOS-ROM 120 (S301). The CPU 102 then determines whether the PC mode is the normal PC mode (S302). When the PC mode is the normal PC mode (Yes at S302), the CPU 102 sets the IDE controller to “Enable” (S303).

Next, the CPU 102 formats the CD-ROM drive 125 and the HDD 126 (S304). Thereafter, the CPU 102 boots up an OS according to the boot priority (S305). Generally, boot from the HDD 126 has the highest priority, and the CPU 102 loads an OS from the HDD 126 and boots up it. Even if the network boot has a higher priority, since the CD-ROM drive 125 and the HDD 126 are accessible, the PC 10 functions as not a thin client PC but a normal PC, after booting up with the network boot.

When the PC mode is the thin client PC mode (No at S302), the CPU 102 sets the IDE controller that controls the CD-ROM drive 125 and the HDD 126 to “Disable” (S306). Subsequently, the CPU 102 boots up an OS according to the boot priority (S307). In this case, access to the CD-ROM drive 125 and the HDD 126 is disabled. This means that even if the boot priority is set such that boot from these drives has a higher priority, the PC 10 cannot boot up from them. Therefore, the CPU 102 boots up the PC 10 with a currently available boot option, i.e., the network boot. After booting up, the PC 10 functions as a thin client PC that does not allow access to the CD-ROM drive 125 and the HDD 126 is disabled.

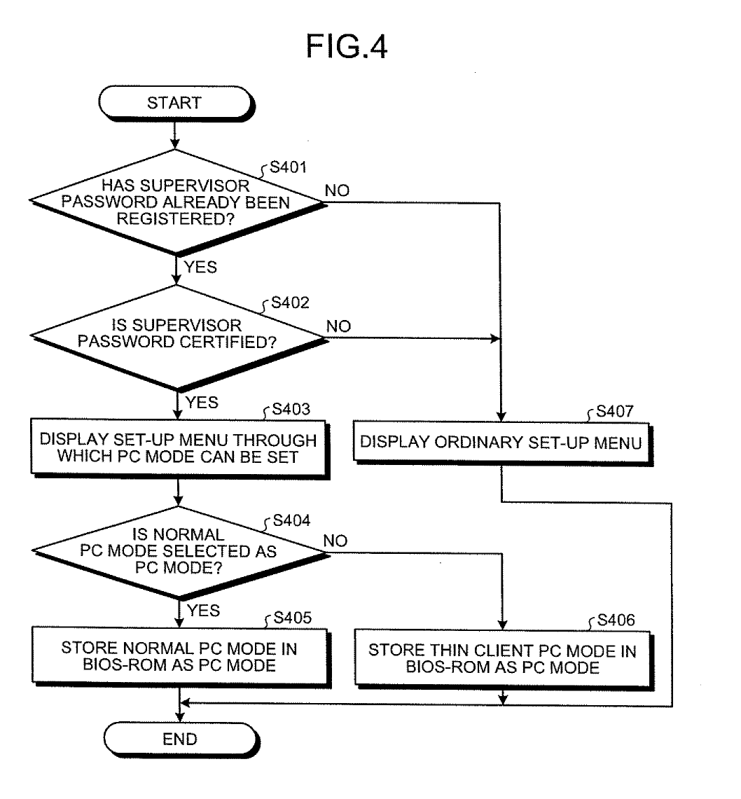

With reference to FIG. 4, a description will be given of a BIOS set-up process on the PC 10 of the embodiment configured as described above. FIG. 4 is a flowchart of the BIOS set-up process according to the embodiment.

The BIOS set-up process is initiated, for example, when the CPU 102 loads a program for BIOS set-up from the BIOS-ROM 120 and executes it in response to the press of a predetermined button after the PC 10 is turned on.

First, the CPU 102 determines whether a supervisor password has already been registered (S401). The supervisor password is a password that is used to perform a predetermined function such as PC mode setting. The supervisor password may be registered by, for example, selecting a password register function on a BIOS set-up menu screen (hereinafter, “set-up menu”).

When a supervisor password has already been registered (Yes at S401), the CPU 102 determines whether the supervisor password is certified. That is, the CPU 102 determines whether an input supervisor password matches the supervisor password already registered (S402). The supervisor password may be input by, for example, selecting a supervisor password check function on the set-up menu. Thus, the CPU 102 determines whether a supervisor password input by a user matches the supervisor password previously registered.

When the supervisor password Is certified (Yes at S402), the CPU 102 displays, on the LCD 16, a set-up menu through which the PC mode can be set (S403).

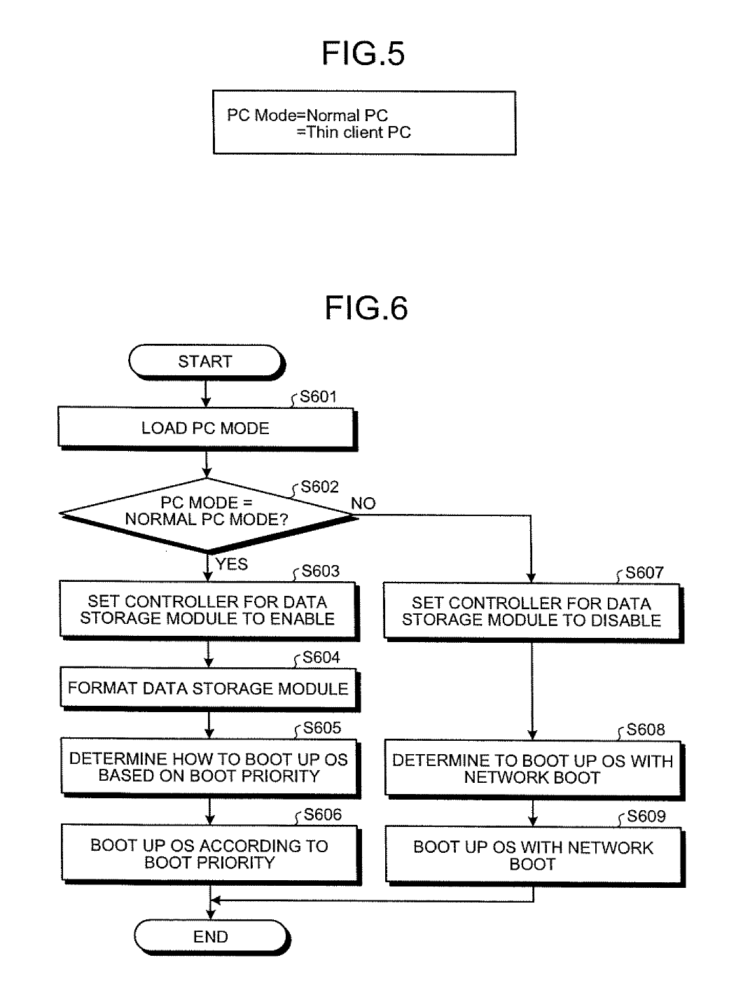

FIG. 5 illustrates an example of the set-up menu. In the example of FIG. 5, the PC mode is set to the normal PC mode (Normal PC). On the set-up menu, for example, a user may move a cursor onto a desired PC mode to select it. Although FIG. 5 illustrates only the PC mode as setting information; however, in general, other setting information such as the boot priority are also displayed on the set-up menu to allow the user to change the settings.

Referring back to FIG. 4, after the set-up menu is displayed, the CPU 102 determines whether the normal PC mode is selected as the PC mode (S404). If the normal PC mode is selected as the PC mode (Yes at S404), the CPU 102 stores the normal PC mode in the BIOS-ROM 120 as the PC mode (S405). If the thin client PC mode is selected (No at S404), the CPU 102 stores the thin client PC mode in the BIOS-ROM 120 as the PC mode (S406). In this manner, the CPU 102 functions as a storing module that stores setting information selected by the user in the BIOS-ROM 120.

When a supervisor password has not yet been registered (No at S401), or when the supervisor password is not certified (No at S402), the CPU 102 displays, on the LCD 16, an ordinary set-up menu not having a function for setting the PC mode (S407).

As described above, according to the embodiment, the information processing apparatus is capable of setting a storage medium such as HDD so that it cannot be physically used based on setting information (PC mode) stored in a nonvolatile memory such as BIOS-ROM. In other words, a commonly used PC provided with a storage medium such as HDD can be used as a thin client PC by simply changing the setting information.

Namely, the information processing apparatus can be used as a thin client PC. This eliminate the need of purchasing a thin client PC, or constructing a mechanism for preventing information from remaining in a storage medium with the OS, drivers, or the like.

Moreover, the PC mode cannot be changed unless the user inputs a password registered in advance by an administrator or the like. This prevents unauthorized change of the PC mode, and thus prevents the information processing apparatus from being available as a normal PC. Therefore, it is possible to avoid any reduction in security.

According to the above embodiment, enabling/disabling of access to the data storage module is switched depending on the PC mode, and one of boot options is selected based on the boot priority without reference to the PC mode. In this case, if the data storage module is disabled when the boot priority is set such that boot from the data storage module has a higher priority, the network boot is not attempted until boot from the data storage module has failed. This causes waste in the process. Thus, according to a modification of the embodiment, when the thin client PC mode is set as the PC mode, the network boot is always selected for booting up the PC 10.

FIG. 6 is a flowchart of a BIOS set-up process according to a modification of the embodiment.

Incidentally, the processes from S601 to S604, i.e., the processes of loading the PC mode, determining the PC mode, and formatting the data storage module, are the same as previously described for S301 to S304 of FIG. 3 illustrating the boot process in the above embodiment. Therefore, their description will not be repeated.

After the process of S604, the CPU 102 determines how to boot up an OS based on the boot priority (S605), and boots up an OS according to the determination. That is, the CPU 102 boots up an OS according to the boot priority as with the process of S303 in FIG. 3 (S606).

When the PC mode is the thin client PC mode (No at S602), as with the process of S306 in FIG. 3, the CPU 102 sets the IDE controller that controls the CD-ROM drive 125 and the HDD 126 to “Disable” (S607).

Besides, the CPU 102 determines to boot up an OS with the network boot (S608), and boots up an OS according to the determination. That is, the CPU 102 boots up an OS with the network boot (S609).

As described above, according to the modification of the embodiment, when the thin client PC mode is set as the PC mode, the PC boots up an OS with the network boot. This eliminates waste in the process that a boot is attempted from the data storage module access to which is disabled.

As set forth hereinabove, according to the embodiment, when the setting information, which is retrieved before an OS boots up, indicates that the PC is in the thin client PC mode, access to the data storage module is disabled. An OS is loaded from a server and is booted up. Thus, an information processing apparatus can be used as a thin client terminal without change or modification of software such as OS.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing apparatus that is connectable to a server that stores a first operating system (OS), the information processing apparatus comprising:
a data storage module configured to store a second OS;
a setting storage module configured to store setting information indicating either a first mode enabling access to the data storage module or a second mode disabling access to the data storage module;
a controller configured to retrieve the setting information from the setting storage module before the first OS or the second OS boots up, and, when the setting information indicates the second mode, disable access to the data storage module, and when the setting information indicates the first mode, enable access to the data storage module; and
a boot module configured to load, when the setting information indicates the first mode, the first OS from the server or the second OS from the data storage module in descending order of predetermined priority and boot up the first OS or the second OS after loading the first OS or the second OS, and configured to load, when the setting information indicates the second mode, the first OS from the server regardless of the priority and boot up the first OS.

2. (canceled)

3. (canceled)

4. (canceled)

5. The information processing apparatus of claim 1, further comprising a storing module configured to receive setting information specified by a user, and store the setting information in the setting storage module.

6. The information processing apparatus of claim 5, wherein the storing module is configured to determine whether the user has predetermined authorization, and, when the user has the authorization, receive the setting information specified by the user and stores the setting information in the setting storage module.

7. A boot method applied to an information processing apparatus that is connectable to a server that stores a first operating system (OS), the information processing apparatus comprising a data storage module configured to store a second OS and a setting storage module configured to store setting information indicating either a first mode enabling access to the data storage module or a second mode disabling access to the data storage module, the boot method comprising:
a controller retrieving, before the first OS or the second OS boots up, the setting information that indicates either a first mode enabling access to the data storage module or a second mode disabling access to the data storage module, and, when the setting information indicates the second mode, disabling access to the data storage module, while when the setting information indicates the first mode, enabling access to the data storage module;
a boot module loading, when the setting information indicates the first mode, the first OS from the server or the second OS from the data storage module in descending order of predetermined priority and booting up the first OS or the second OS after loading the first OS or the second OS, and loading, when the setting information indicates the second mode, the first OS from the server regardless of the priority and booting up the first OS.

8. The boot method of claim 7, further comprising a storing module receiving setting information specified by a user, and storing the setting information in the setting storage module.

9. The boot method of claim 8, further comprising the storing module determining whether the user has predetermined authorization, wherein
when the user has the authorization, the storing module receives the setting information specified by the user and stores the setting information in the setting storage module.
